(19) United States
(12) Patent Application Publication
(10) Pub. No.: US 2006/0196006 A1
(43) Pub. Date: Sep. 7, 2006

(54) ARTICULATED CASTER

(76) Inventor: Douglas G. Willis, Colby, KS (US)

Correspondence Address: HOVEY WILLIAMS LLP, 2405 GRAND BLVD., SUITE 400, KANSAS CITY, MO, 64108, US

(21) Appl. No.: 11/277,538

(22) Filed: Mar. 27, 2006

Related U.S. Application Data
(63) Continuation-in-part of application No. 10/886,369, filed on Jul. 6, 2004.

(51) Int. Cl. B60B 33/00

(52) U.S. Cl. 16/47

(57) ABSTRACT

A carriage including an articulated caster is disclosed. The carriage includes a frame with a load-supporting section and a base section that pivots relative to the load-supporting section and pivotally attaches to three casters. The frame further includes a pivot block that cooperates with the sections to provide a universal joint that permits the relative pivotal movement between the sections. The universal joint includes pivot axes that are spaced below the horizontal axes of the caster wheels so that forces applied by the load-supporting section through the joint are prevented from tipping the carriage. The caster wheels are spaced relative to the joint so that the base section provides a walking-beam suspension. The carriage further includes a preferred direction of travel whereby the casters are positioned on the base section to approach an obstacle in sequential order when traveling along the preferred direction.

### RELATED APPLICATION

This application is a continuation-in-part of U.S. patent application Ser. No. 10/886,369, filed Jul. 6, 2004, entitled ARTICULATED CASTER, which is hereby incorporated by reference herein.

### BACKGROUND OF THE INVENTION

1. Field of the Invention

The present invention relates generally to casters and wheeled load-supporting carts. More specifically, the present invention concerns a cart or carriage that includes multiple-wheeled casters.

2. Discussion of Prior Art

Carts with one or more single-wheel casters are known in the art and are employed in a wide variety of applications including personal, retail, and industrial applications. Carts employing one or more multiple-wheel frames for supporting loads, especially very heavy loads, are also known in the art.

Prior art carts with casters and multiple-wheel load-supporting mechanisms are problematic and suffer from certain limitations. For example, prior art carts, particularly those that use casters, are prone to tipping. These carts generally are susceptible to such tipping because shifting of the supported load causes a tipping moment to be applied to one or more of the wheels. Also, prior art carts are ineffective at traveling over obstacles positioned on a floor surface. Accordingly, there is a need for an improved caster that does not suffer from these problems and limitations.

### SUMMARY OF THE INVENTION

A first aspect of the present invention concerns a carriage for supporting a load above a surface. The carriage broadly includes a load-supporting frame section and a caster assembly. The caster assembly includes a base frame section and at least three spaced apart caster wheels that are attached to and cooperatively support the base frame section so that the caster assembly is self-supporting. The frame sections are pivotally interconnected relative to a pivotal joint that permits relative pivotal movement of the sections about a substantially horizontal base pivot axis. Each of the caster wheels includes a wheel axis. The base pivot axis is spaced closer to the surface than the wheel axes so as to reduce the risk of carriage tipping.

A second aspect of the present invention concerns a caster-supported carriage for supporting a load above a surface. The carriage broadly includes a load-supporting frame section and a caster assembly. The caster assembly includes a base frame section and at least three spaced apart caster wheels that are attached to and cooperatively support the base frame section so that the caster assembly is self-supporting. The frame sections are pivotally interconnected relative to a pivotal joint that permits relative pivotal movement of the sections about a substantially lateral base pivot axis. The caster wheels are spaced laterally from each other along a direction orthogonal to the base pivot axis so that the caster wheels are configured to approach a surface obstruction sequentially when the carriage moves along the orthogonal direction.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a fragmentary upper perspective view of an articulated caster constructed in accordance with a preferred embodiment of the present invention;

FIG. 2 is a fragmentary lower perspective view of the articulated caster shown in FIG. 1;

FIG. 3a is a fragmentary perspective view of the articulated caster shown in FIGS. 1 and 2, particularly showing a brake disengaged with a brake arm in a retracted position;

FIG. 3b is a fragmentary perspective view of the articulated caster similar to FIG. 3a, but showing the brake lever being shifted downward so that the brake arm contacts the surface but prior to the brake being engaged;

FIG. 3c is a fragmentary perspective view of the articulated caster similar to FIG. 3a, but showing the brake engaged with the brake arm contacting the surface;

FIG. 3d is a fragmentary perspective view of the articulated caster similar to FIG. 3a, but showing the brake being released;

FIG. 4 is a fragmentary upper perspective view of the articulated caster shown in FIGS. 1-3, showing the brake in a disengaged position;

FIG. 5 is a lower perspective view of an articulated caster constructed in accordance with a second embodiment of the present invention;

FIG. 6 is an upper perspective view of the articulated caster shown in FIG. 5;

FIG. 7 is a perspective view of an articulated caster constructed in accordance with a third embodiment of the present invention;

FIG. 8 is a lower perspective view of an articulated caster constructed in accordance with a fourth embodiment of the present invention;

FIG. 9 is a fragmentary perspective view of an articulated caster constructed in accordance with a fifth embodiment of the present invention;

FIG. 10 is a partially-exploded perspective view of the articulated caster of FIG. 9;

FIG. 11 is a lower perspective view of the articulated caster shown in FIG. 7;

FIG. 12 is an upper perspective view of an articulated caster constructed in accordance with another embodiment of the present invention;

FIG. 13 is a fragmentary lower perspective view of the articulated caster shown in FIG. 12;

FIG. 14 is an exploded fragmentary perspective view of the articulated caster shown in FIGS. 12 and 13, showing a joint of the caster assembly;

FIG. 15 is a fragmentary top view of the articulated caster shown in FIGS. 12-14, showing the caster assembly;

FIG. 16 is an enlarged side view of the articulated caster taken along line 16-16 in FIG. 15;

FIG. 17 is an enlarged side view of the articulated caster shown in FIG. 16, showing the base assembly in a pivoted position to overcome a surface obstacle;

FIG. 18 is an enlarged cross-sectional side view of the articulated caster taken along line 18-18 in FIG. 15; and

FIG. 19 is an enlarged cross-sectional side view of the articulated caster taken along line 19-19 in FIG. 15.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The figures illustrate various embodiments of a carriage constructed in accordance with a preferred embodiment of the present invention. The disclosed carriage embodiments provide a stable platform for supporting relatively large loads. Small caster wheels are incorporated into the carriage for providing the carriage with a low profile. However, these small casters are not strong enough individually to support the kind of load intended for placement on the disclosed carriage embodiments. Instead, the disclosed embodiments permit the application of large loads by including a large number of small casters with the carriage being able to permit load-sharing between the casters. The large number of casters also allows the disclosed carriage embodiments to be moved over the surface by the application of relatively small lateral forces, even while supporting a substantial load. While the illustrated embodiments are primarily intended for industrial load supporting applications, the principles of the present invention are equally applicable in other personal or consumer applications (e.g., computer, instrumentation, and medical applications). Such applications may involve mobile load-carrying devices such as carts, trailers, or hand trucks.

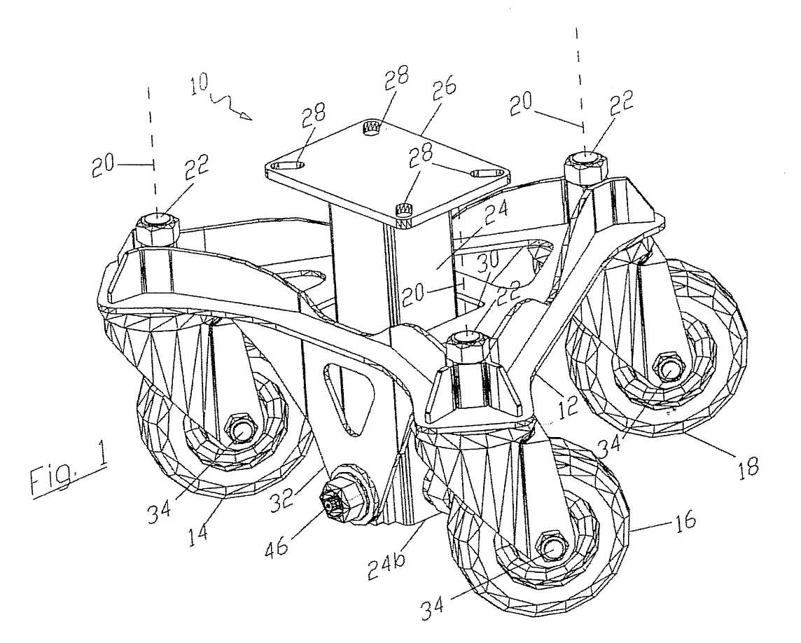

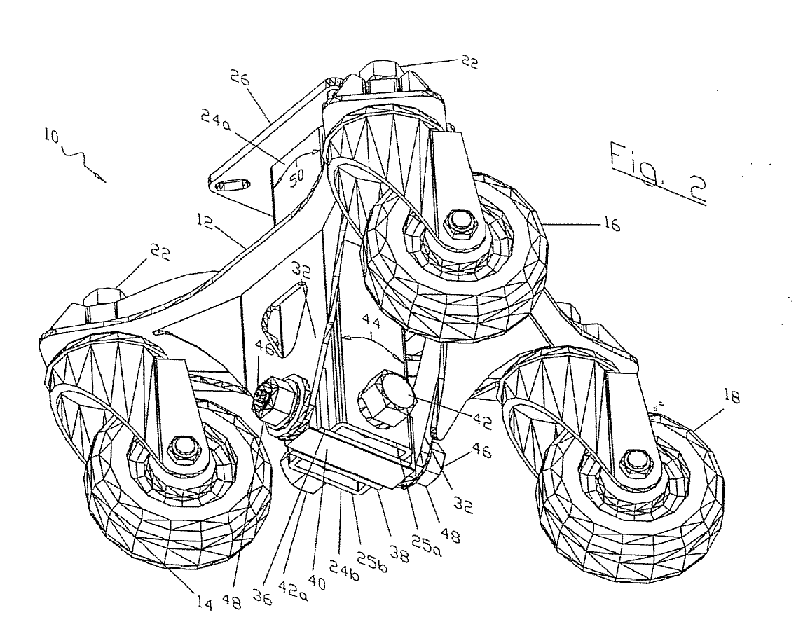

Referring to FIG. 1 and FIG. 2, an articulated caster is shown, identified in general by the reference numeral 10.

A base assembly 12 preferably includes a lead wheel 14 and two trailing wheels 16, 18. All wheels 14-18 preferably rotate about a vertical axis 20 that passes through a mounting bolt 22 of each wheel 14-20.

The two trailing wheels 16, 18 are preferably also staggered so that they are not parallel. This helps smooth movement when a surface irregularity is encountered.

A pivot arm 24 includes an upper end 24a and an opposite lower end 24b. The upper end 24a is attached to a flange plate 26. The flange plate includes bolt holes 28 and is used to attach the caster 10 to an object (not shown) that is to be supported by the caster 10.

The pivot arm 24 passes through a correspondingly shaped opening 30 in the base assembly 12. The base assembly 12 includes a pair of side members 32 that extend down on opposite sides of the opening 30 to a location that is, preferably, lower than that of an axle 34 of each of the wheels 14-18. The side members 32 are securely attached to the base assembly 12.

All load (i.e., the weight of the object) that is applied to each caster 10 is transferred through the pivot arm 24 to a lower end of both of the side members 32. This is described in greater detail hereinafter.

However, it is important to note that by transferring the load to a location within the caster 10 that is proximate or below the axles 34, as the object is moved laterally (along the surface), there is no force applied to the caster 10 above the axles 34. This provides a low effective center of gravity for the caster 10 as it supports the weight of the object, thereby making the caster 10 especially stable.

Referring now primarily to FIG. 2, the lower end 24b of the pivot arm 24 includes a first side 25a and an opposite second side 25b. A rectangular opening is provided in the lower end 24b, of the pivot arm 24 intermediate the first side 25a and the second side 25b. The rectangular opening is open at the lower end 24b, and it extends up along the longitudinal length of the pivot arm 24 for a predetermined distance.

A first side plate 36 is attached to the first side 25a, and a second side plate 38 is attached to the second side 25b. Attachment, as used anywhere herein, is by any preferred method. It can include welding, molding together as a unit, bolts and nuts, or any other method.

A pivot block 40 is inserted in the space between the first and second side plates 36, 38. The pivot block 40 can move in the space, as is described hereinbelow, yet the fit between the pivot block 40 and the side plates 36, 38 includes minimal tolerance and, therefore, minimal slack.

A first bolt 42 passes through an opening in the first side 25a, through a coincident opening in the first side plate 36, through a coincident opening through the pivot block 40, through a coincident opening in the second side plate 38, and through a coincident opening in the second side 25b. The first bolt 42 is secured in place, preferably by a lock nut 42a or other locking means.

The pivot arm 24 is adapted to pivot from side to side, as shown by arrow 44, with respect to the pivot block 40. This defines a first axis of pivoting for the pivot arm 24 with respect to the base assembly 12 (i.e., through a longitudinal axis of the first bolt 42). Obviously, the pivot arm 24 cannot pivot more than the space intermediate the pivot arm 24 and the opening 30 in the base assembly 12 allows.

The pivot block 40 includes a pair of threaded extensions (not shown) that extend from the center of the pivot block 40 and which pass through two openings provided on opposite sides of the side members 32 as low as possible. A grease fitting 46 is preferably attached to each threaded extension wherein each threaded extension includes an opening that is adapted to convey grease into the pivot block 40. If preferred, only one grease fitting 46 may be used.

A pair of lock nuts 48 cooperate with threads on the threaded extensions and are used to secure the pivot block 40 to the side members 32. The pivot block 40, therefore, acts as a second bolt to secure the pivot arm 24 to the base assembly 12 and as one which includes a longitudinal axis that is always perpendicular with respect to the first bolt 42.

Another embodiment, also preferable, is to include the grease fitting 46 in a hollow bolt (in this alternate embodiment, also as shown, the hollow bolt is identified by reference number 48), which, accordingly, shows the head of the hollow bolt 48 and where the hollow bolt 48 screws into threads that are provided in an end of the pivot block 40.

The pivot block 40 is adapted to pivot from side to side, as shown by arrow 50, with respect to the side members 32, and within the limits as afforded by the opening 30. This defines a second axis of pivoting for the pivot arm 24 (i.e., around the longitudinal center of the pivot block 40) with respect to the base assembly 12.

Accordingly, the caster 10 is adapted to pivot about two axes that are perpendicular to each other with respect to the base assembly 12. It is possible to use angles other than perpendicular for special purposes. The longitudinal axis of the first bolt 42 is in line with the normal direction (i.e., line) of travel. The longitudinal axis of the pivot block 40 (the second bolt) is preferably disposed at a 90 degree angle with respect to the normal direction of anticipated movement by the caster 10. This allows the wheels 14-18 of the caster to overcome surface irregularities with ease.

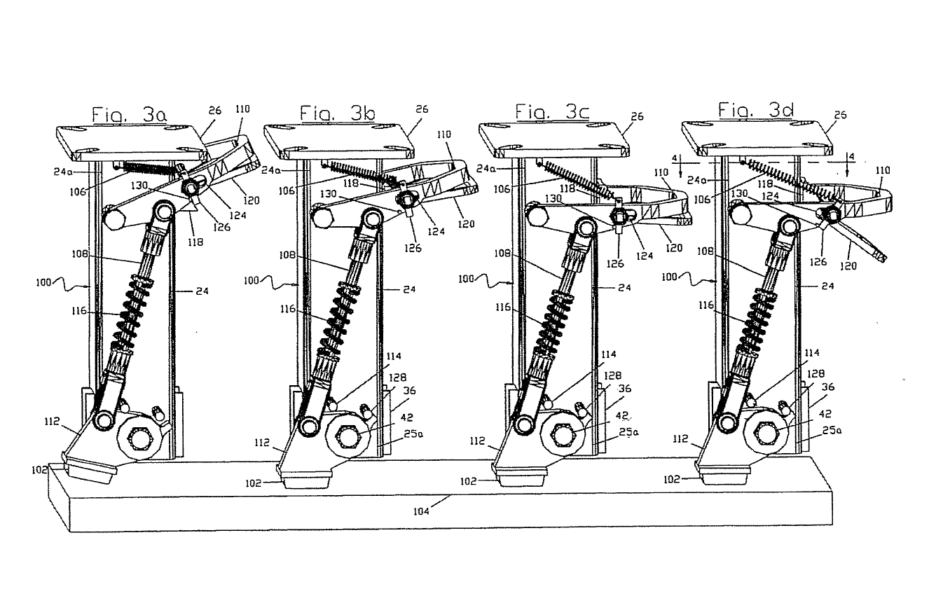

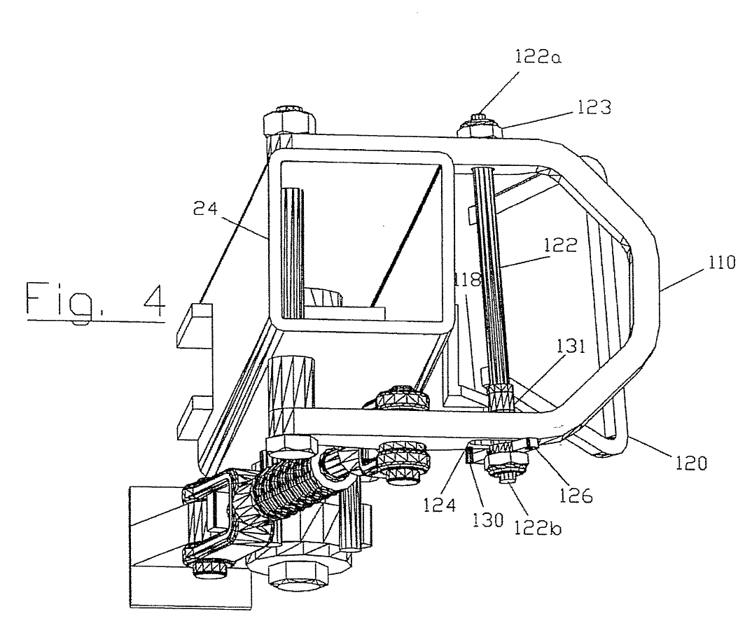

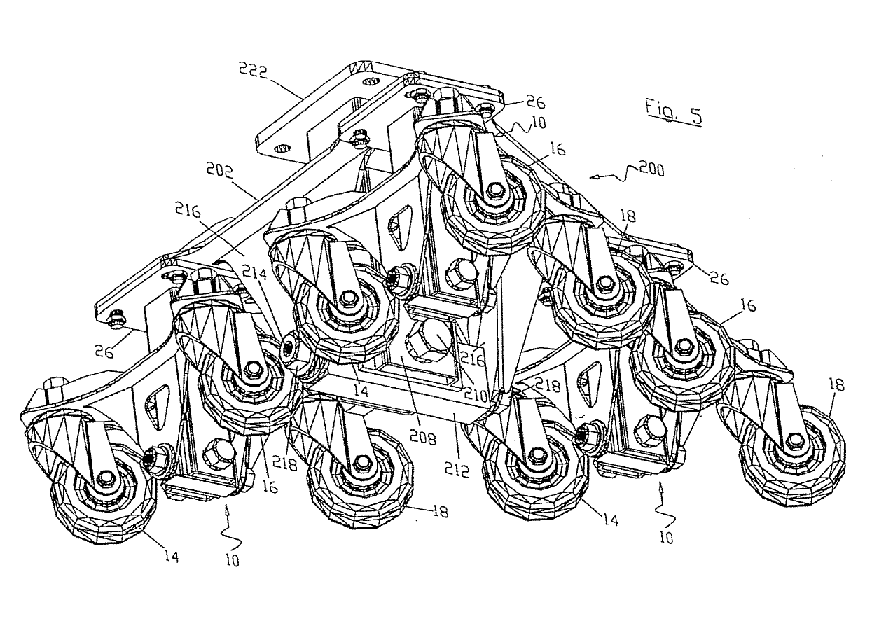

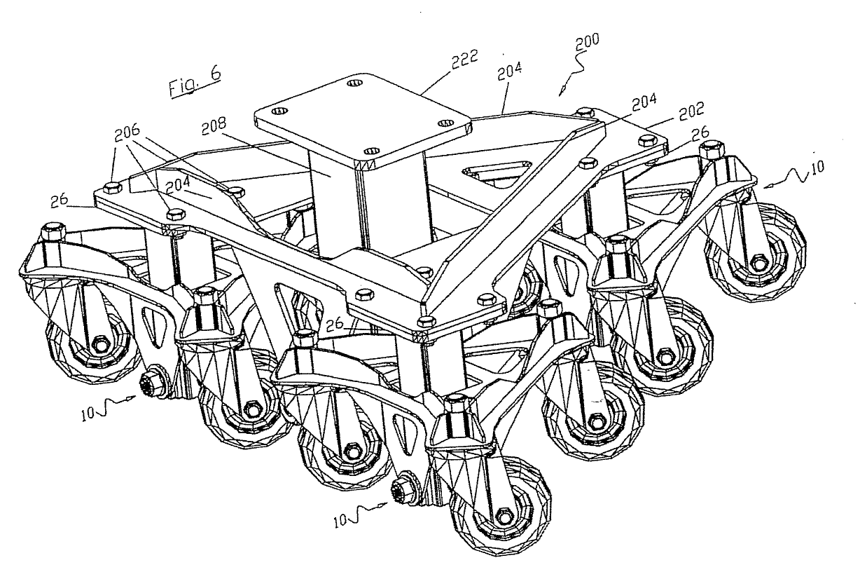

Referring now in particular also to FIGS. 3a-3d and also on occasion to FIG. 4, is shown a brake assembly, identified in general by the reference numeral 100.

FIG. 3a shows the brake assembly 100 in a first retracted position in which a brake pad 102 is elevated above a surface 104.

A return spring 106 is holding the brake assembly 100 in the first retracted position. This ensures that no braking force is applied when the brake assembly 100 is released (i.e., when it is in the first position).

A pivot rod 108 is pivotally attached at an upper end to a brake lever 110 and at an opposite end to a brake pad support member 112. The brake pad support member 112 is attached over one end of the first bolt 42, about which it is adapted to pivot.

There are of course other ways of pivotally attaching the brake pad support member 112. For example, a sleeve (not shown) may be welded to the pivot arm 24 and another bolt may be used to engage threads in the sleeve allowing the brake pad support member 112 to pivot about the other bolt or sleeve as desired. Alternatively, a pivot pin may be used as well as bushings, etc. These variations are useful in diminishing wear or improving smoothness of operation.

A first stop pin 114, attached to the pivot arm 24, prevents the brake pad support member 112 from retracting further, as urged by the return spring 106.

The pivot rod 108 preferably bears against a compression spring 116. In the first position, the compression spring 116 is somewhat relaxed because the pivot rod 108 is not supplying a force that is attempting to compress it.

A latch plate 118 is attached to one side of the pivot arm 24. The latch plate 118 includes an upper tapered surface and a flat bottom surface. A brake release lever 120 includes a shaft 122 that includes a first end 122a which passes through a hole provided in one side of the brake lever 110. A shaft nut 123 secures the shaft to the brake lever 110. The shaft 122 is adapted to rotate and tilt slightly within the holes provided.

The shaft 122 includes an opposite end 122b that passes through a slot 124 provided in an opposite side of the brake lever 110. An end rod 126 is attached to the opposite end 122b of the shaft 122. The end rod 126 retains the opposite end 122b of the shaft 122 in the slot 124.

One end of the return spring 106 is attached to one end of the end rod 126. The return spring 106 tends to urge the opposite end 122b of the shaft 122 of the brake release lever 120 to the left of the slot 124, as shown (i.e., toward the pivot arm 24). The return spring 106 also urges the brake release lever 120 toward the first position. In the first position, the shaft 122 is disposed adjacent to the left side of the slot 124 and above the latch plate 118.

As is described in greater detail hereinafter, the opposite end 122b of the shaft 122 is adapted to extend over the upper tapered surface of the latch plate 118 as it is lowered. Once the shaft 122 is below the flat bottom surface of the latch plate 118, the return spring 106 urges the opposite end 122b under the flat bottom surface, thereby retaining the shaft 122 and brake lever 110 in a second position in which a braking force is applied.

FIG. 3b shows the brake assembly 100 as a braking force is being applied. The brake lever 110 has been urged downward sufficiently so that a bottom edge of the brake pad 102 is beginning to contact the surface 104. The brake pad 102 is a replaceable wear item that is chosen for the specific application to provide an optimum coefficient of friction intermediate the brake pad 102 and the surface 104.

The opposite end 122b is extended away from the pivot arm 24 by the latch plate 118. Careful examination reveals that in FIG. 3b, the opposite end 122b of the shaft 122 is on the verge of being urged downward sufficient to clear the flat bottom surface of the latch plate 118. The return spring 106 is fully extended.

FIG. 3c shows the brake assembly 100 in the second fully engaged position. The brake lever 110 has been lowered by the user sufficient so that the shaft 122 has cleared the bottom of the latch plate 118. The return spring has urged the opposite end 122b of the shaft 122 to the left of the slot 124 and under the flat bottom surface of the latch plate 118 where the latch plate 118 now retains the brake lever 110 in the second position.

In this position, the brake pad 102 is lowered an amount sufficient to cause the lower surface of the brake pad 102 to be disposed below the surface 104. This preferably compresses the spring 116 and brake pad 102, or it may alternatively attempt to raise the object, or both. It is generally not preferred that the object be raised a greater amount above the surface 104 when the brake assembly 100 is engaged. A positive frictional engagement intermediate the pivot arm 24 of the caster 10 and the surface 104 by the brake pad 102 is what is desired and attained.

This eliminates the possibility of movement occurring intermediate the wheels 14-18 and the surface 104, a problem with prior types of caster brakes which can cause unwanted movement of the object being supported by the caster 10. It does not matter if the wheels 14-18 move or not, the object is stable and the caster 10 is applying a braking force directly to the surface 104.

Depending on the intended application of the caster 10, the amount of compression of the pad 102, the material chosen for the pad 102, and the stroke of the brake lever 110 (i.e., the downward and upward range of extension of the brake pad 102) are varied as desired. These and other factors are all design-specific variables. Accordingly, the brake assembly 100 is locked and engaged with the surface 104. It is latched in the second position and cannot be dislodged or released without further action, as described hereinafter.

It is also readily apparent to the user whether or not the brake assembly 100 is engaged. If the brake lever 110 is raised (i.e., if it is close to the flange plate 26), the brake is in the first position and no braking force is applied. If the brake lever 110 is displaced away from the flange plate 26, it is in the second position and maximum braking force is applied. A second stop pin 128 prevents over rotation of the brake pad support member 112.

The spring 116 is maximally compressed in the second position. This allows a constant force to be applied to the brake pad 102. The spring 116 also compensates for irregularities in the surface 104 and also for wear of the brake pad 102 over time.

FIG. 3d shows the brake assembly 100 being released from the second latched position. As shown, it is ready to automatically retract, under force supplied by the return spring 106, back into the first position.

To release the brake assembly 100, the brake release lever 120 is urged downward. As the brake release lever 120 is urged downward, the end rod 126 rotates. As the end rod 126 rotates, a bottom portion thereof contacts and bears against a brake release pin 130 that is attached to the brake lever 110.

As additional force is applied to the brake release lever 120 in a downward direction, the end rod 126 continues to bear against the brake release pin an amount sufficient to urge the opposite end 122b of the shaft 122 away from the pivot arm 24 until the opposite end 122b clears the latch plate 118, as shown in FIG. 3d.

The brake lever 110 is now free to return to the first position. Normally, the user allows the brake lever 110 to return quickly with a snap. An audible snap is heard on engagement and also on release. The spring 116 also supplies a force that, on release, helps urge the brake lever 110 to return to the first position.

If for some reason (i.e., an especially sensitive load being supported) and the user preferred, he or she could also gently allow the brake lever 110 to return to the first position rather than releasing all contact and allowing return spring 106 to urge it back abruptly.

Referring back to FIG. 4 momentarily, a roller sleeve 131 is disposed over the shaft 122 and is free to rotate about the shaft. The roller sleeve 131 is in contact with the latch plate 118 and because it rotates, it allows for easier and smoother operation.

Several important advantages are provided by the brake assembly 100. First, the location of brake is always the same when viewed from above. This allows the user to quickly access and apply the brake whereas with prior art caster brakes that are disposed on the wheels, their position varies and accordingly, they can not be quickly accessed as the wheels wobble or change directions.

Second, the brake can be applied safely and easily even while in transit. With prior art caster brakes, there is danger that the user can actually place his foot under the wheels where it can be run over or severely pinched. While not generally preferred, in an emergency or in anticipation of a needed stop, the brake assembly 100 can be quickly, safely, and predictably applied while in motion.

Third, the brake assembly 100 has two positions. The first position is no brake force whatsoever is applied. The second position is full, normal brake force is applied. The brake is either set (applied) or it is not. This produces predictable results. Prior caster brakes produce uncertain variable results where the braking force can vary widely. Worse yet, this variance can occur without any tactile or visual feedback occurring.

Prior caster brakes also are not securely latched and therefore are prone to sudden unpredictable release with possible damage to the object or even impact to people and other objects occurring.

Fourth, the report (noise) that occurs on setting (when the latch bar 122 snaps into place) and release provides a clear indication of the braking status to the user. When the brake is set, the user feels this engagement, typically through his shoe and into his foot. It is similarly felt on release. Either position can be verified visually as well, thereby providing confirmation of position via three senses, hearing, feeling, and sight.

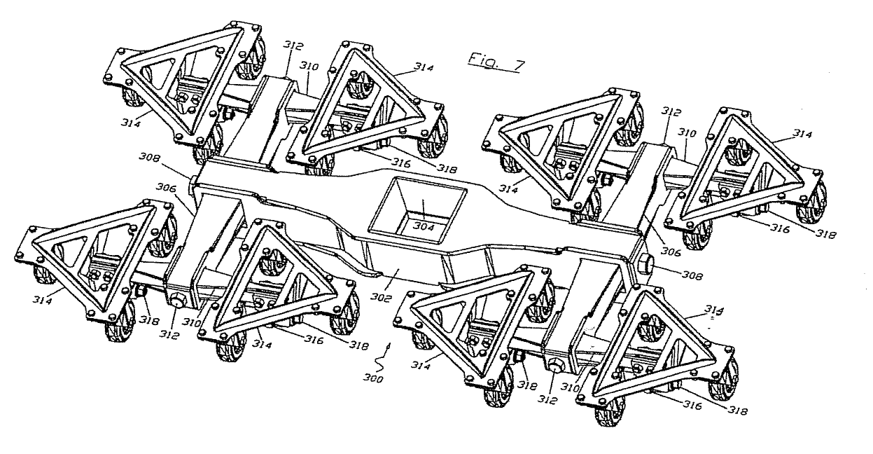

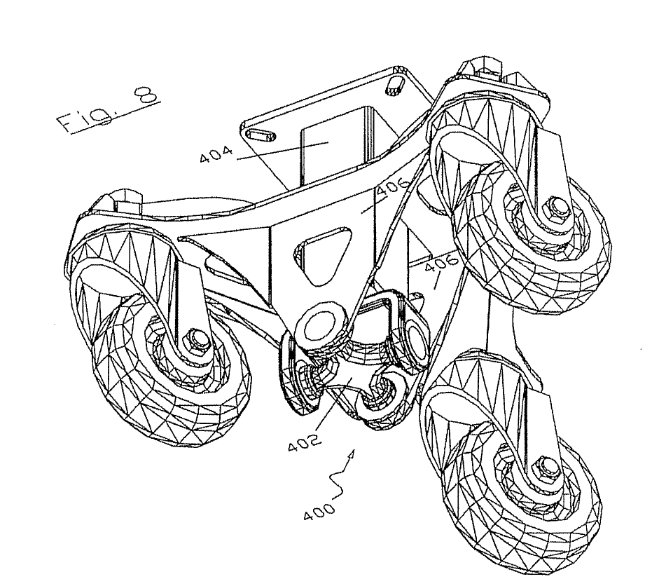

Referring now to FIG. 5 and FIG. 6, is shown a modified articulated caster, identified in general by the reference numeral 200.

While the articulated caster 10, can of course be scaled to any desired size to accommodate a need for greater (or lesser) payload (i.e., carrying capacity), there is a potential disadvantage that can arise when substantially heavier payloads are encountered and a mere increase in the size of the articulated caster 10 is employed. That potential disadvantage is for the flange plate 26 to be elevated substantially higher as a result of an increased wheel 16 diameter size.

The modified articulated caster 200 solves this potential disadvantage by arranging three (or any number) of the articulated casters 10 together and attaching the flange plates 26 of each to an adapter plate 202.

The adapter plate 202 includes gusset plates 204 that are added to reinforce it, as necessary. Each of the flange plates 26 is secured to the adapter plate 202 by a plurality of bolts 206.

An enlarged pivot arm 208 is similar to the pivot arm 24 of the articulated caster 10. An enlarged first bolt 210 is used to secure the enlarged pivot arm 208 to an enlarged pivot block 212.

The enlarged pivot arm 208 is adapted to pivot about a center longitudinal axis of the enlarged first bolt 210 with respect to the enlarged pivot block 212.

A pair of enlarged threaded extensions 214 that extend from opposite sides of the enlarged pivot block 212 each pass through one of a pair of enlarged side members 216. A pair of enlarged lock nuts 218 secure each end of the enlarged pivot block 212 to one of the enlarged side members 216.

The enlarged pivot block 212 is adapted to pivot about a center longitudinal axis thereof with respect to the enlarged side members 216.

Together, the enlarged pivot block 212 and the enlarged first bolt 210 provide two-axis pivoting (i.e., a universal joint) for the enlarged pivot arm 208 with respect to the adapter plate 202 within a space provided by an enlarged opening 220 in the adapter plate 202.

An enlarged flange plate 222 is attached to an upper end of the enlarged pivot arm 208 and is used to attach the modified articulated caster 200 to either a platform or directly to a heavy object (not shown) with a substantial increase in carrying capacity and only a slight increase in height above grade of the enlarged flange plate 222 as compared to that of the flange plate 26.

Another benefit provided by the modified articulated caster 200 is an ability for all caster wheels 14, 16, 18 to individually adapt to small changes in the grade without substantially affecting the plane of the adapter plate 202 or the heavy object. In other words, the heavy object is not raised or lowered with respect to grade as the individual caster wheels 14-18 pass over small changes or fluctuations in the surface upon which they bear.

This makes is easier to move the heavy object because horizontal movement is free of vertical movement. It also provides a smoother ride for the heavy object, which does not rise and fall in response to the small fluctuations experienced by the wheels 14-18. This smoother ride helps prevent damage to the heavy object, much the same as the articulated caster 10 provides a smoother, safer ride for the object that it supports during transport.

Another benefit provided by the modified articulated caster 200 is that substantial changes in grade, for example changes in the slope of the grade that are encountered, are compensated for by movement (i.e., arising and falling) of the individual wheels 14-18 as well as by the various articulated casters 10.

As the articulated casters 10 respond to changes in grade or when they must rise over more substantial objects (not shown), these changes are transferred to the adapter plate 202, which pitches in response to these variations. However, the heavy object remains substantially unaffected, disposed on the same plane above grade, due to the universal joint action provided by the mounting of the enlarged pivot arm 208 with respect to the adapter plate 202.

The combined ability of the individual articulated casters 10 to adapt to changes in grade by the wheels 14-18, and of the adapter plate 202 to adapt to more substantial changes in grade provides a method of supporting an object (or heavy object) that allows for optimum ease of transport, maintains the object at nearly a predetermined elevation above grade, keeps that elevation as low as possible even when a substantial carrying capacity is required, and isolates the payload (i.e., the object or heavy object) from fluctuations that occur on the surface. Rolling resistance is actually decreased. It becomes easier to change direction as well. Greater and more uniform floatation over the surface is attained as well.

Of course, any number of the articulated casters 10 can be used with a modified adapter plate (not shown). It is also possible to duplicate the overall process described above for even larger payloads or whenever greater floatation, less rolling resistance, or easier direction change is desired. For example, the enlarged flange plate 222 of the modified articulated caster 200 can be attached to a modified enlarged adapter plate (not shown) in which a plurality of the modified articulated casters 200, each of which having a plurality of articulated casters 10, can be used.

It is noted that typically, as more and more casters 10 are used, their size is scaled down accordingly. This provides the desired benefits with lower structures that better distribute the load and compensate for surface irregularities. Smaller wheels 14, 16, 18 can be used with multiple groupings of the casters 10 and still climb over substantial obstacles because of the articulation and floatation characteristics obtained.

A preferred method of distributing the load over a number of different carriages (i.e., the articulated casters 10) through the universal (or cross-axis) type of joints is herein disclosed. It is also possible to mount any of the joints (for the articulated caster 10 or the modified articulated caster 200) in a manner that provides pivotal motion about only one axis, instead of about two axes simultaneously, as the preferred embodiments herein disclose.

The modified articulated caster 200 can, of course, also be used with the brake assembly 100, as disclosed for with the articulate caster 10, as desired. If desired, a modified enlarged brake assembly (not shown) can be attached to the enlarged pivot arm 208.

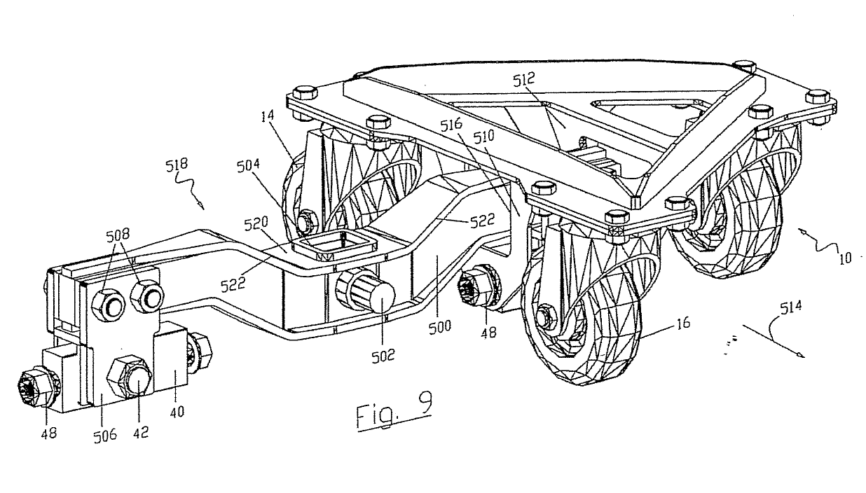

Referring now to FIG. 7 is shown a second modified articulating caster, identified in general by the reference numeral 300.

The second modified articulated caster 300 includes a central beam 302 to which a payload object (not shown) is attached to a center recess 304 thereof.

A pair of transverse beams 306 are attached to opposite ends of the central beam 302 by an end bolt 308. Each of the transverse beams 306 is adapted to pivot around the axis of the end bolts 308 a limited amount.

Attached to each end of each transverse beam 306 is a second transverse beam 310. Each second transverse beam 310 is adapted to pivot around a second end bolt 312 that secures the second transverse beam 310 to each end of the transverse beam 306.

Accordingly, pivoting about two axes is provided, the first axis being with respect to a center longitudinal axis of the end bolt 308 and the second being with respect to a center longitudinal axis of the second end bolt 312, the two axes being perpendicular with respect to each other.

The end of each of the second transverse beams 310 is pivotally attached to a caster assembly 314 by a caster pivot bolt 316. The caster pivot bolt 316 provides an axis that is parallel to that of the second end bolt 312 and it allows the caster assembly 314 to articulate about the caster pivot bolt 316.

This allows the smaller caster assemblies 314 to articulate about this axis to accommodate smaller fluctuations in the surface while the second end bolt 312 allows the second transverse beams 310 to pivot about a parallel axis to accommodate larger variations in the grade of the surface without substantially affecting the position of the central beam 302. Usually, the smaller caster assemblies 314 are able to adapt and accommodate the greater part of any variations in the grade of the surface.

A lower caster pivot bolt 318 includes a longitudinal axis that is parallel to that of the end bolts 308 and allows the caster assemblies 314 to pivot about this axis to accommodate smaller grade fluctuations while the transverse beams 306 similarly pivot about the end bolts 308 to accommodate larger grade fluctuations.

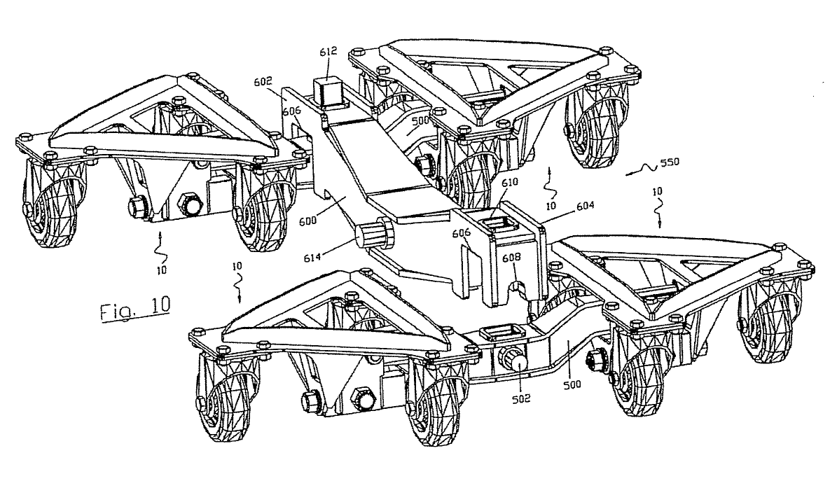

It is important to note that the second transverse beam 310 extends out of the side of the caster assembly 314. This provides substantial benefits where low structure height is attained. This general concept is discussed in greater detail hereinafter (see discussion appertaining to FIG. 9).

Referring now to FIG. 8 is shown a third modified caster 400 that includes a conventional type of a universal joint 402 attached to a modified pivot arm 404 and to a pair of second modified side members 406.

The second modified side members 406 are each adapted to retain a bearing race into which the end of the universal joint 402 is secured.

The modified pivot arm 404 is adapted to retain a pair of bearing races into which the two remaining ends of the universal joint 402 are secured.

Accordingly, the modified pivot arm 404 is adapted also to pivot about two axes that are perpendicular with respect to each other, each one of the two axes passing through an opposite end of the universal joint 402.

While the universal joint 402 may be used to provide the desired articulation for the third modified caster 400, it may be more difficult to assemble, maintain, or replace that the previously disclosed embodiments and it is reserved for those applications where it use is preferred.

Referring now to FIG. 9 is shown a horizontal pivot arm 500. The horizontal pivot arm 500 does not extend upward from the caster 10 but rather extends out from the side while still maintaining the full range of articulation as previously described. A very low profile is also achieved because the horizontal pivot arm 500 does not extend upward. Other substantial benefits are also attained by use of the horizontal pivot arm 500 and are described hereinafter.

Each end of the horizontal pivot arm 500 is attached to one of the casters 10. Only the right caster 10 is shown in the drawing figure. The left caster is not shown to better illustrate how the horizontal pivot arm 500 is attached to each of the casters 10 so as to maintain articulation about the two axes.

The horizontal pivot arm 500 is secured to a pair of raised side members 506 by a pair of bolts 508. Each of the raised side members 506 are, in turn, pivotally attached to the pivot block 40 by the first bolt 42. The threaded extensions of the pivot block 40 are secured by the pair of lock nuts 48 and pivotally secure the pivot block 40 to a second modified side member 510 and to an opposite side member 512.

The second modified side member 510 is disposed between two of the caster 10 wheels 14, 16. A preferred direction of movement by the caster 10 is shown by arrow 514. The second modified side member 510 includes a plane that generally aligns with the arrow 514.

An enlarged side member opening 516 is provided in the second modified side member 510 through which the horizontal pivot arm 500 extends. The enlarged side member opening 516 provides clearance for the horizontal pivot arm 500 to move relative to the second modified side member 510 as the caster 10 changes attitude during transit in response to irregularities of the floor surface beneath the caster 10.

The opposite side member 512 does not require the enlarged side member opening 516 because the horizontal pivot arm 500 does not pass through it, although the enlarged side member opening 516 can be included in the opposite side member 512, if desired.

The horizontal pivot arm 500 includes a lower portion in the middle identified in general by the reference numeral 518. The lower portion 518 includes a flat bottom member 520 connected to two angled sides 522.

A circular bearing shaft 502 is attached to an outside of the lower portion 518, below the flat bottom member 520.

A center load point 504 opening is provided proximate the bearing shaft 502. The circular bearing shaft 502 is useful for connecting a plurality of the horizontal pivot arms 500 together, for multiple ganging of the casters 10, and it use is described in greater detail hereinafter.

The lower portion 518 keeps the geometry low, which allows for a lowered elevation of any object, which is preferred. The horizontal pivot arm 500 allows for connection together of a pair of casters 10 (only the one is shown) to divide and support the weight of the load between them. Accordingly, each caster 10 supports only about one-half the load while still fully adapted to articulate about the two axes with respect to the horizontal pivot arm 500.

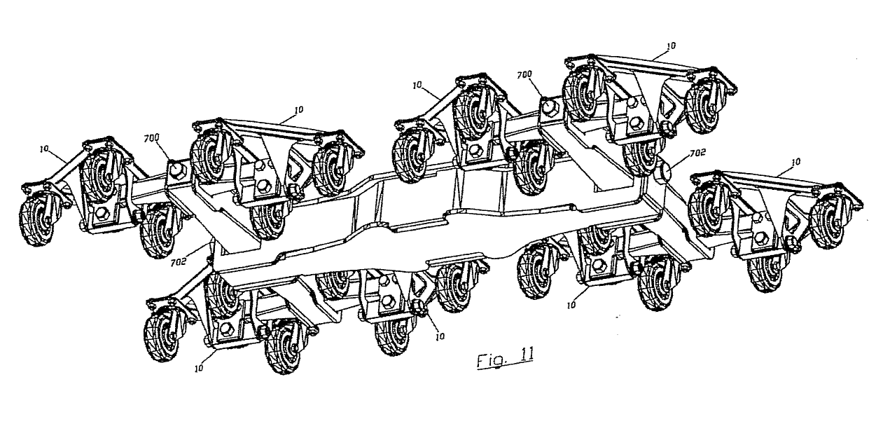

Referring now to FIG. 10 is shown an interlocking system, identified in general by the reference numeral 550. Four casters 10 are each connected together in pairs by one of the horizontal pivot arms 500.

The two pairs of interconnected casters 10 are then disposed in a parallel spaced-apart orientation. An intermediate member 600 is used to connect the two pairs of casters 10 together and it includes a lowered center portion and a pair of opposite ends 602, 604.

The opposite ends 602, 604 include side cutouts 606 that allow each end of the intermediate member 600 to be placed atop a center of the lower portion 518 of a respective one of the horizontal pivot arms 500. An arcuate cutout 608 is provided at each of the opposite ends 602, 604.

The arcuate cutout 608 rests on top of the bearing shaft 502 thereby allowing for side to side articulation of the intermediate member 600 along a center longitudinal axis of the bearing shaft 502 and with respect to each of the horizontal pivot arms 500. A center load point connection 610 allows passage of a load member 612 to the horizontal pivot arm 500 or, if preferred, the connection can occur within the opposite ends 602, 604, as desired. The load member 612 conveys the weight of the load to the device.

The intermediate member 600 is simply placed atop the two horizontal pivot arms 500. The arcuate cutout 608 and the side cutouts 606 secure the two horizontal pivot arms 500 to the intermediate member 600. In use, any applied load only tends to further urge the intermediate member 600 down thereby further securing it to the two horizontal pivot arms 500. This allows for rapid “ganging” (i.e., joining) together of pairs of the casters 10.

A second bearing shaft 614 attached to the intermediate member 600 allows another intermediate member (not shown) to be placed over two of the intermediate members 600 thereby connecting eight casters 10 together. This further distributes the weight of the load while allowing each individual caster 10 to articulate over surface irregularities.

This results in the capacity to transport up to heavy loads that are not elevated above the surface a significant amount and to do so with especially low rolling resistance. Also, being able to utilize a great many wheels 14, 16, 18 to support a load (whenever two or more of the casters 10 are used) allows for a wide selection in the type of material used to form the wheels (the portion that contacts the surface). Softer materials can be used as well as hard materials.

A wide range of design flexibility is thereby attainable. Materials, for example, that can withstand insertion into an environmental chamber and which can experience a wide temperature variation, but which have a limited load carrying ability can now be used to form the wheels 14, 16, 18 when multiple groups of the casters 10 are ganged together. Other more economical materials can similarly be used. Materials that provide increased friction, low rolling noise, etc. can instead be used to form the wheels 14, 16, 18 that previously, when a single type of a conventional caster (not shown) was used, were not viable design choices.

Referring now to FIG. 11 is shown another method for ganging multiple pairings of the casters 10 together, which is similar to that shown in FIG. 7. The method shown includes pivot bolts 700, 702 that pivotally secure the assemblies together, which pass through openings that are provided. For certain applications, this is preferred. The example shown includes eight casters 10, although any number of casters 10 can be connected together, as desired, in any of a variety of possible ways.

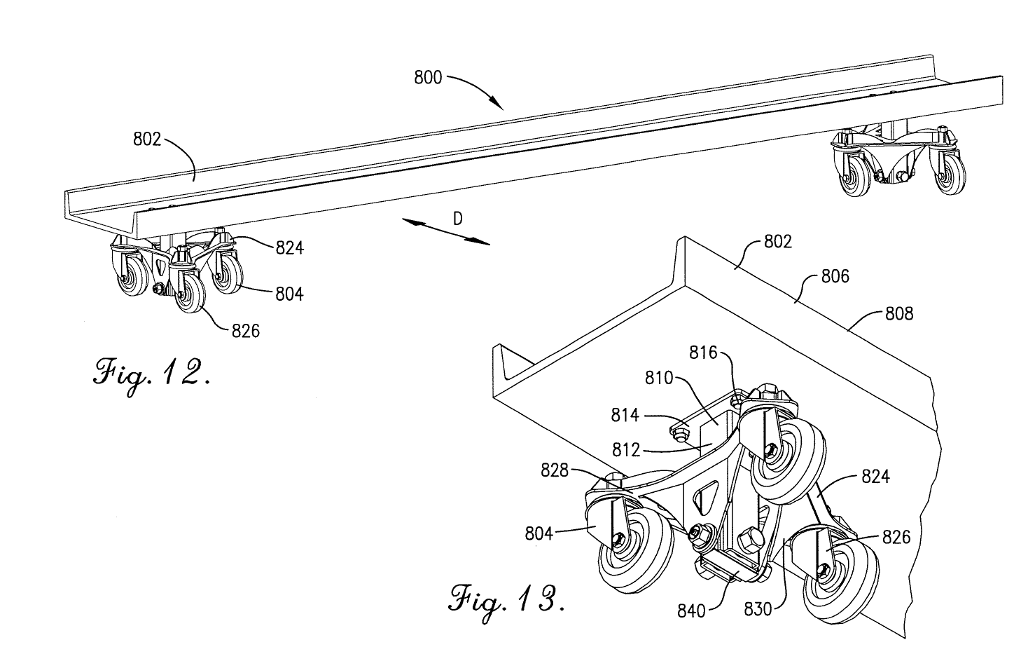

Turning to FIGS. 12-19, an alternative embodiment of the present invention is depicted. Some of the concepts associated with the alternative embodiment may be found in the other embodiments discussed above but are also presented in further detail below.

Initially turning to FIGS. 12 and 13, an alternative carriage 800 provides a stable platform for supporting relatively large loads with small caster wheels, even if the carriage 800 is moved across an irregular surface. The carriage 800 broadly includes a frame 802 and a caster assembly 804.

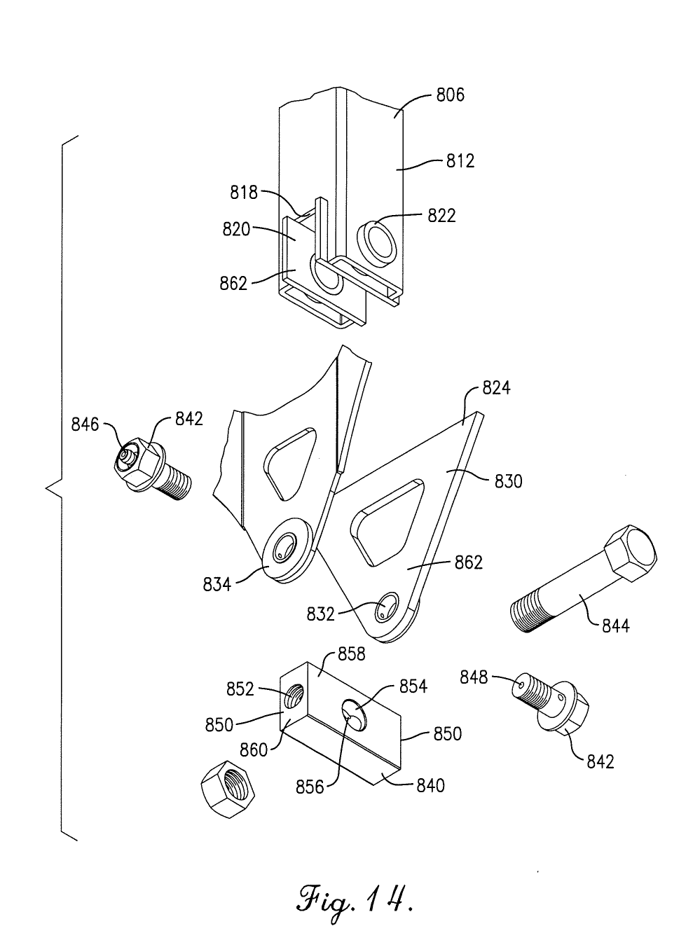

The frame 802 includes an articulated load-supporting section 806 including a substantially horizontal channel 808 and uprights 810. Each upright (or pivot arm) 810 (see FIG. 13) includes a post 812 and a flange 814 fixed to the post 812. The flange 814 includes holes (not shown) through which fasteners 816 extend for attaching the upright 810 to the channel 808. The post 812 includes a transverse slot 818 (see FIG. 14). The uprights 810 further include shim plates 820 spaced within the slot 818, and bushings 822 that extend through the post 812. The shim plates 820 provide bearing surfaces as will be discussed. The principles of the present invention are equally applicable to a section 806 having an alternative shape or structure, such as a chassis, cart, trailer, hand truck, or other mobile load-supporting structure.

The channel 808 and pivot arms are attached so that the frame 802 is relatively rigid and is thereby suitable for supporting a load (not shown). However, the principles of the present invention are equally applicable to a frame with a load-supporting section and other frame sections or arm sections pivotally attached thereto, such as those illustrated in some of the previous embodiments discussed above. The load could be fastened, secured, or otherwise supported by the carriage 800 in a variety of configurations consistent with the principles of the present invention.

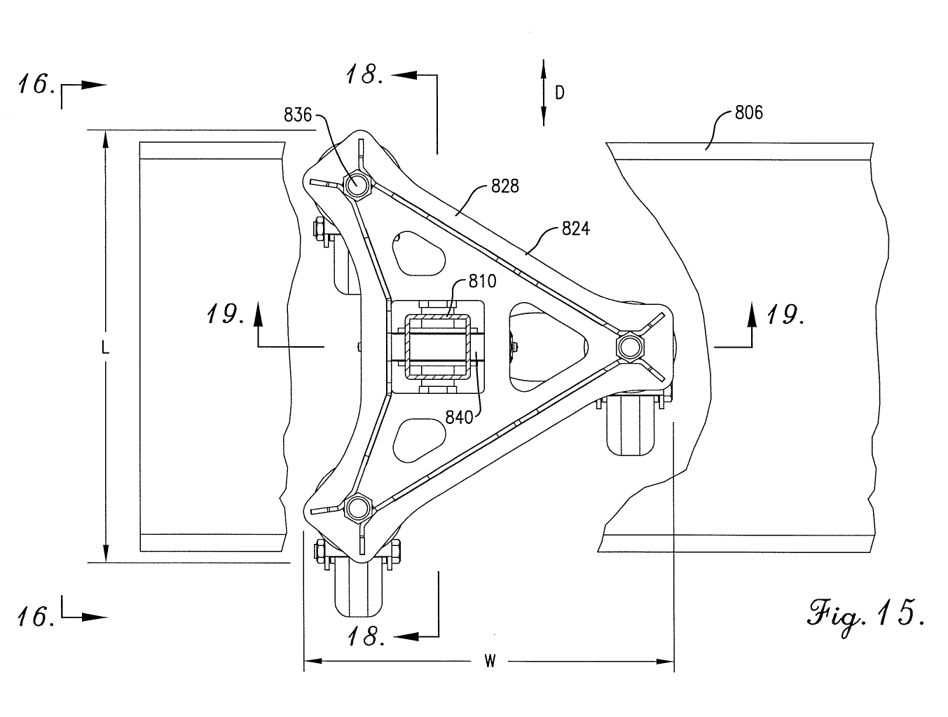

Turning to FIG. 13, the caster assembly 804 further includes base frames 824 and casters 826, with the base frames 824 each interconnecting three of the casters 826 in a triangular orientation. The base frames 824 are substantially unitary and rigid. Each base frame 824 includes a substantially flat caster attachment portion 828 and upright bracket portions 830 extending downwardly from the attachment portion 828. The bracket portions 830 each have a bore. Each base frame 824 further includes bushings 832 that extend through the respective bores and spacers 834 that are mounted on the bushings 832 (see FIG. 14). The caster attachment portion 828 includes integral spaced apart flanges with holes for receiving mounting bolts 836 that attach the casters 826 as will be discussed. The base frames 824 preferably have a length L of about 11.5 inches and a width W of about 10 inches (see FIG. 15). Additional details of another similarly constructed and preferred base section are disclosed in the incorporated Application.

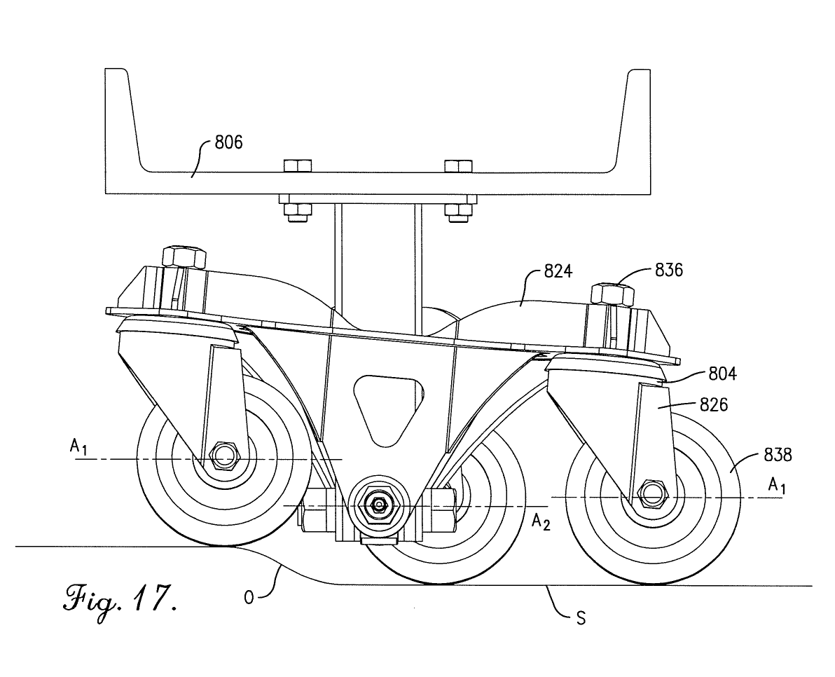

Turning to FIG. 17, the casters 826 include a pivotal body, with the mounting bolt 836 and a caster wheel 838 that is rotatably mounted within the pivotal body. The caster wheel 838 preferably has a diameter of about 3.5 inches and is preferably made of nylon, but could also be made of other materials such as steel or rubber. The casters 826 preferably have a load capacity of between about 200-300 pounds. The term caster, as used herein when referring to a single wheel, is defined to include a rotatable wheel that is pivotally coupled to a structure, preferably about an upright axis.

The casters 826 are attached to the base frames 824 with mounting bolts 836 that extend through the flange holes. With respect to each of the base frames 824, three of the casters 826 are preferably spaced apart in a triangular arrangement with substantially equal spacing therebetween. The height H of the base frame 824 on the preferred caster assembly 804 is about 5.5 inches. The preferred caster assembly 804 is stable and can support itself independently of other supporting structure. For each base frame 824, two of the casters 826 are longitudinally spaced fore-and-aft along a preferred direction of travel D. A third caster 826 is transversely spaced from the two casters 826 and longitudinally spaced between the two casters 826. The third caster 826 allows the caster assembly 804 to support itself independently of other supporting structure. While the preferred caster assembly 804 has three casters 826 as discussed above, the principles of the present invention are applicable to a caster assembly 804 with alternative types of wheels 838, alternative numbers of casters 826, or an alternative arrangement of the casters 826 relative to the base frame 824 (e.g., unequal spacing, relative positioning, etc.).

Turning to FIGS. 14, 18 and 19, the frame 802 further includes a pivot block 840 with fasteners 842,844 for assembling the caster assembly 804 and the load-supporting section 806. The threaded fasteners 842 include a grease fitting 846 and a bore 848 that communicates with the grease fitting 846. The illustrated block 840 has a solid form and is elongated with ends 850 spaced apart so that the block 840 closely fits between the bracket portions 830. The block 840 further includes threaded axial holes 852 that extend from each end 850 and a transverse through-hole 854 that is perpendicular to the threaded holes 852 and extends through the middle of the block 840. The block 840 also includes an annular groove 856 that partly encircles the through-hole 854 for purposes that will be discussed shortly. While the illustrated block 840 is solid and substantially shaped as a cuboid, the principles of the present invention are applicable to a pivotal member having alternative shapes.

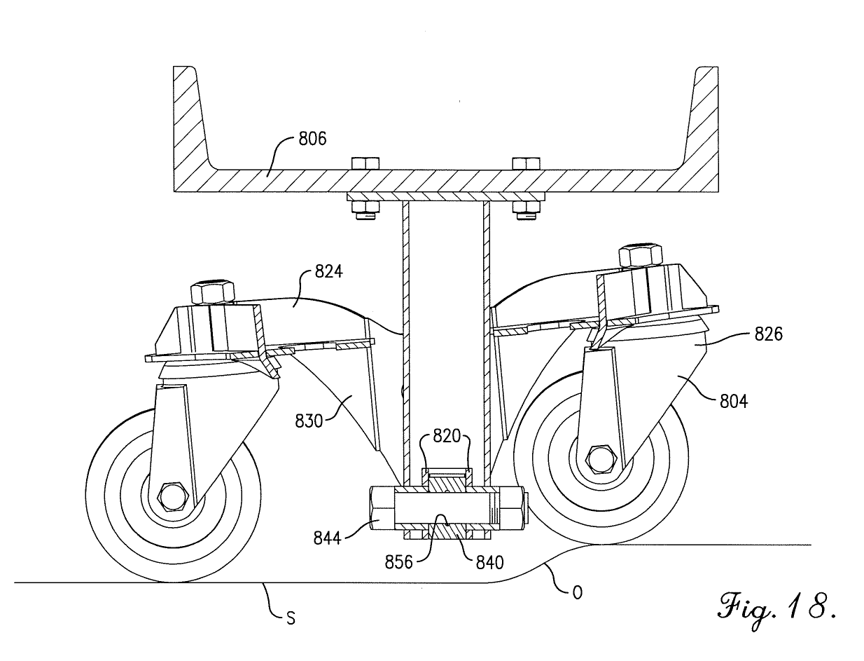

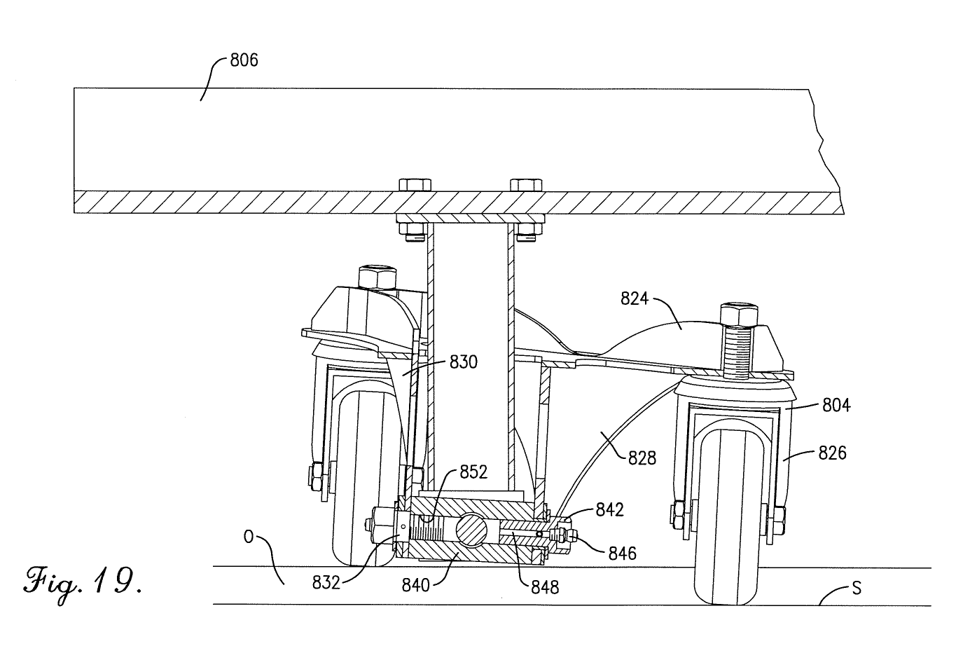

Turning to FIGS. 18 and 19, the block 840 is arranged with each end 850 adjacent to one of the bracket portions 828. The threaded holes 852 are aligned with the bores of the bracket portions 830. The bolt fasteners 842 are extended through the bushing 832 and threaded into the block 840 to secure the block 840 within the base frame 824 and permit relative pivotal movement therebetween about a longitudinal axis of the block 840. The load-supporting section 806 is attached to the block 840 by arranging it in the transverse slot 818 and between the shim plates 820 (see FIG. 18). Also, the fastener 844 includes a bolt that is extended through the bore of the post 812 and the through-hole 854. Thus, the load-supporting section 806 is pivotal relative to the block 840 about a transverse axis of the block 840. The caster assembly 804 and the load-supporting section 806 are joined with the block 840 in a pin-and-block universal joint assembly with the base frame 824 being pivotal relative to the load-supporting section 806 and with the axes being aligned longitudinally and transversely relative to the channel 808. However, the principles of the present invention are equally applicable to assembling the caster assembly 804 and the load-supporting section 806 with other types of universal joints or pivotal joints (e.g., a ball-and-socket joint).

Each caster assembly is pivotal about the fasteners 842,844 and relative to the load-supporting section 806 to provide a “walking-beam” suspension. Thus, the illustrated walking-beam suspension permits all of the casters 826 attached to the base frame 824 to remain in contact with the surface as the caster assembly travels over the obstacle O or an otherwise uneven surface (assuming of course that the obstacle or surface undulations are not too severe). The illustrated walking-beam thereby permits load-sharing between the frames 824 and between the individual casters 826.

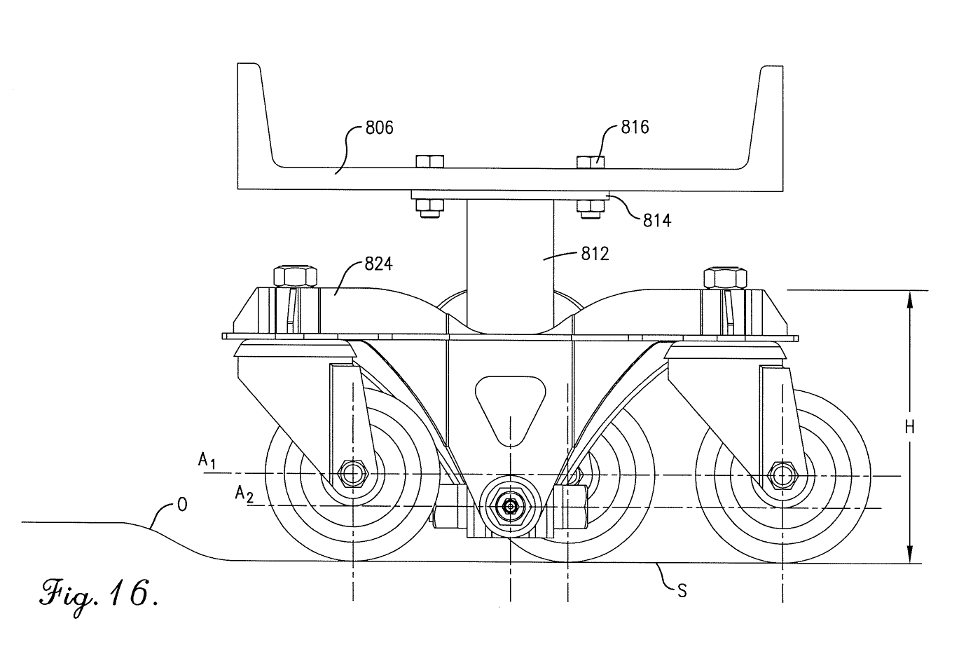

Turning to FIG. 15, the individual caster assemblies are arranged to have substantially the same preferred direction of travel D. Again, when traveling along the preferred direction of travel D, the casters 826 of each caster assembly 804 pass sequentially over obstacle O (see FIGS. 16-19). In other words, in a given direction of travel (e.g., direction of travel D), the casters 826 are preferably arranged so that multiple ones thereof do not encounter the obstacle O simultaneously, which minimizes the typing force the carriage experiences when crossing the obstacle. In addition, travel over transverse obstacle O is further permitted by the universal joint in that the pivotal joint permits the caster assembly to pivot about the transverse and longitudinal pivotal axis relative to the load-supporting section 806 as it travels over obstacle O. Additional preferred details concerning the illustrated arrangement of casters within the carriage as well as other preferred caster arrangements are disclosed in the incorporated Application.

Turning again to FIG. 14, the load-supporting section 806, base frame 824, and block 840 are also configured and assembled to minimize play or backlash therebetween during pivotal movement about the respective pivot axes discussed above. In particular, the block 840 includes opposite longitudinal bearing surfaces 858 that extend between the ends 850. The block 840 also includes opposite transverse bearing surfaces 860 adjacent to each of the ends 850. The surfaces 858 are substantially flat and parallel to each other and parallel to the longitudinal axis of the block 840. The surfaces 860 are substantially flat and parallel to each other and parallel to the transverse axis of the block 840. The shim plates 820 and bracket portions 830 include substantially flat bearing surfaces 862 that slidably engage the corresponding surfaces 858,860 and thereby support the block 840. While the illustrated bearing surfaces 858,860,862 are preferably flat in regards to some aspects of the invention, the surfaces 858,860,862 may be alternatively shaped for other purposes. In particular, the principles of the present invention are applicable where the surfaces 858,860,862 include conical or spherical shapes that permit relative sliding between two pivotal frame sections.

Turning to FIG. 16, the casters 826 are vertically spaced relative to the base frame 824 so that the wheel axes (indicated by line A₁) are spaced above longitudinal and transverse base pivotal axes (indicated by line A₂) of the caster assembly when the base frame 824 is substantially level (e.g., when the base frame 824 is supported on a substantially level surface S). In other words, the pivot axes A₂ are spaced closer to the surface S than the wheel axes A₁. In this manner, loads applied through the joint are prevented from applying a moment about one of the casters 826 that would tend to tip the caster assembly over. In other words, any lateral forces F applied to the base frame 824 through the joint would necessarily be directed below the adjacent wheel axes A₁ because there would generally be no upwardly acting component force. Thus, the lateral force F tends to urge the casters 826 into engagement with the surface S and thereby stabilize the caster assembly rather than make it unstable.

Turning to FIG. 17, the carriage 800 retains its inherent stability even as it travels over obstacle O. Moreover, as the carriage 800 ascends the obstacle O, the longitudinal and transverse axes A₂ become further spaced below the axis A₁ of the leading wheel to increase the caster assembly's stability in the ascending direction. Even if the caster assembly is shifted in a descending direction from the obstacle O, the longitudinal and transverse axes A₂ remain spaced below the axis A₁ of the trailing wheel.

In the event a substantial tipping force is applied to the carriage 800, the carriage 800 is further stabilized by a shifting pivot location or fulcrum that is cooperatively provided by the caster assembly 804 and the load-supporting section 806. Generally, a cart with a single-wheel caster will tip about the wheel axis of the caster. In the illustrated carriage 800, the load-supporting section 806 initially pivots about the joint due to a tipping force, so that the joint provides a fulcrum. The post 812 is pivotal within the opening of the base frame 824. However, as the load-supporting section 806 pivots in a direction to contact the base frame 824 at a contact location, further pivotal movement of the load-supporting section 806 along the direction can cause the caster assembly 804 to tip so that one of the casters 826 is not contacting the surface S. Thus, one or more of the casters 826 remaining in contact with the surface S provides a new fulcrum about which the carriage 800 pivots. In other words, the fulcrum shifts in the direction that the carriage 800 is being tipped and the carriage 800 thereby includes a mechanism that resists tipping by acting in response to the tipping force.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A caster-supported carriage for supporting a load above a surface, the carriage comprising:
a load-supporting frame section; and
a caster assembly including a base frame and at least three spaced apart caster wheels that are attached to and cooperatively support the base frame so that the caster assembly is self-supporting,
said load-supporting frame section and said caster assembly being pivotal relative to one another about a substantially horizontal base pivot axis,
each of said caster wheels including a wheel axis,
said base pivot axis being spaced closer to the surface than the wheel axes so as to reduce the risk of carriage tipping.

2. The carriage as claimed in claim 1,
a pair of said caster wheels being spaced oppositely from the base pivot axis so that the caster assembly operates as a walking beam.

3. The carriage as claimed in claim 1,
said load-supporting frame section and said caster assembly being pivotal relative to one another about at least two substantially orthogonal pivot axes, with one of the pivot axes being the base pivot axis.

4. The carriage as claimed in claim 3; and
a pivot block pivotally attached to the base frame about a first one of the axes and being pivotal relative to the load-supporting frame section about a second one of the axes.

5. The carriage as claimed in claim 1,
said load-supporting frame section and said caster assembly being pivotally interconnected at a pivotal joint permitting relative pivotal movement about the base pivot axis.

6. The carriage as claimed in claim 1; and
an intermediate frame section pivotally interconnected to the base frame at a first pivotal joint permitting relative pivotal movement about the base pivot axis,
said intermediate frame section being pivotally interconnected to the load-supporting frame section at a second pivotal joint for permitting the load-supporting frame section to pivot relative to the intermediate frame section about an intermediate pivot axis,
said second pivotal joint being spaced laterally from the first pivotal joint so that the caster assembly is operable to translate vertically relative to the second pivotal joint about the intermediate pivot axis.

7. The carriage as claimed in claim 1;
an intermediate frame section pivotally interconnected to the base frame at a first pivotal joint permitting relative pivotal movement about the base pivot axis,
said intermediate frame section being pivotally interconnected to the load-supporting frame section at a second pivotal joint for permitting the load-supporting frame section to pivot relative to the intermediate frame section about an intermediate pivot axis,
a second caster assembly spaced from the first-mentioned caster assembly,
said second caster assembly including a second base frame and at least three spaced apart caster wheels that are attached to and cooperatively support the second base frame so that the second caster assembly is self-supporting,
said intermediate frame section being pivotally interconnected to the second base frame at a third pivotal joint.

8. The carriage as claimed in claim 7,
said third pivotal joint permitting relative pivotal movement between the intermediate frame section and the second base frame about a second base pivot axis,
each of said caster wheels of the second caster assembly including a wheel axis,
said second base pivot axis being spaced closer to the surface than the wheel axes of the corresponding caster wheels so as to reduce the risk of carriage tipping.

9. The carriage as claimed in claim 7,
said second pivotal joint being spaced between the first and third pivotal joints so that the intermediate frame section operates as a walking beam.

10. The carriage as claimed in claim 7,
said third pivotal joint permitting relative pivotal movement between the intermediate frame section and the second base frame about a second base pivot axis,
said base pivot axes being substantially parallel to the intermediate pivot axis.

11. The carriage as claimed in claim 7,
said first and third pivotal joints each permitting relative pivotal movement between the intermediate frame section and the respective base frame about at least two substantially orthogonal pivot axes.

12. The carriage as claimed in claim 11; and
a pair of pivot blocks each interconnecting a corresponding one of the base frames and the intermediate frame section,
each of said pair of pivot blocks being pivotally attached to the intermediate frame section about a first one of the pivot axes and pivotally attached to the respective base frame about a second one of the pivot axes.

13. The carriage as claimed in claim 7,
said base frames each including an opening that receives the intermediate frame section therein,
said base frames each being operable to contact the intermediate frame section along the respective opening in a selected orientation to limit relative pivotal movement therebetween.

14. The carriage as claimed in claim 7,
said third pivotal joint permitting relative pivotal movement between the intermediate frame section and the second base frame about a second base pivot axis,
said intermediate frame section being pivotal relative to one of the base frames in a first direction about the respective base pivot axis,
said intermediate frame section being configured to engage said one of the base frames when said intermediate frame section has pivoted into a base-engaging position, wherein further pivoting of the intermediate frame section relative to said one of the base frames in the first direction is prevented,
one of said caster wheels of one of the corresponding caster assemblies being spaced from the corresponding pivotal joint in the first direction, such that any pivoting of the intermediate frame section in the first direction beyond the base-engaging position occurs about said one of said caster wheels.

15. The carriage as claimed in claim 14,
said intermediate frame section contacting said one of the base frames at a contact location when said intermediate frame section is pivoted into the base-engaging position,
said one of said caster wheels being spaced further in the first direction from the corresponding pivotal joint than the contact location.

16. The carriage as claimed in claim 1,
said caster wheels being spaced laterally from each other along a direction orthogonal to the base pivot axis so that the caster wheels are configured to approach a surface obstruction sequentially when the carriage moves along the orthogonal direction.

17. A caster-supported carriage for supporting a load above a surface, the carriage comprising:
a load-supporting frame section; and
a caster assembly including a base frame and at least three spaced apart caster wheels that are attached to and cooperatively support the base frame section so that the caster assembly is self-supporting,
said load-supporting frame section and said caster assembly being pivotal relative to one another about a substantially lateral base pivot axis,
said caster wheels being spaced laterally from each other along a direction orthogonal to the base pivot axis so that the caster wheels are configured to approach a surface obstruction sequentially when the carriage moves along the orthogonal direction.

18. The carriage as claimed in claim 17,
a pair of said caster wheels being spaced oppositely from the base pivot axis so that the caster assembly operates as a walking beam.

19. The carriage as claimed in claim 17,
said load-supporting frame section and said caster assembly being pivotal relative to one another about at least two substantially orthogonal pivot axes, with one of the pivot axes being the base pivot axis.

20. The carriage as claimed in claim 19; and
a pivot block pivotally attached to the base frame about a first one of the axes and being pivotal relative to the load-supporting frame section about a second one of the axes.

21. The carriage as claimed in claim 17,
said load-supporting frame section and said caster assembly being pivotally interconnected at a pivotal joint permitting relative pivotal movement about the base pivot axis.

22. The carriage as claimed in claim 17; and
an intermediate frame section pivotally interconnected to the base frame at a first pivotal joint permitting relative pivotal movement about the base pivot axis,
said intermediate frame section being pivotally interconnected to the load-supporting frame section at a second pivotal joint for permitting the load-supporting frame section to pivot relative to the intermediate frame section about an intermediate pivot axis,
said second pivotal joint being spaced laterally from the first pivotal joint so that the caster assembly is operable to translate vertically relative to the second pivotal joint about the intermediate pivot axis.

23. The carriage as claimed in claim 17;
an intermediate frame section pivotally interconnected to the base frame at a first pivotal joint permitting relative pivotal movement about the base pivot axis,
said intermediate frame section being pivotally interconnected to the load-supporting frame section at a second pivotal joint for permitting the load-supporting frame section to pivot relative to the intermediate frame section about an intermediate pivot axis; and
a second caster assembly spaced from the first-mentioned caster assembly,
said second caster assembly including a second base frame and at least three spaced apart caster wheels that are attached to and cooperatively support the second base frame so that the second caster assembly is self-supporting,
said intermediate frame section being pivotally interconnected to the second base frame at a third pivotal joint.

24. The carriage as claimed in claim 23,
said third pivotal joint permitting relative pivotal movement between the intermediate frame section and the second base frame about a second base pivot axis,
said caster wheels of said second caster assembly being spaced laterally from each other along a direction orthogonal to the second base pivot axis so that said caster wheels of said second caster assembly are configured to approach a surface obstruction sequentially when the carriage moves along the orthogonal direction.

25. The carriage as claimed in claim 24,
said caster wheels of said first and second caster assemblies being spaced laterally from each other along a direction substantially parallel to said orthogonal directions so that said caster wheels of said first and second caster assemblies are configured to approach a surface obstruction sequentially when the carriage moves along the direction.

26. The carriage as claimed in claim 23,
said third pivotal joint permitting relative pivotal movement between the intermediate frame section and the second base frame about a second base pivot axis,
each of said caster wheels of the second caster assembly including a wheel axis,
said second base pivot axis being spaced closer to the surface than the wheel axes of the corresponding caster wheels so as to reduce the risk of carriage tipping.

27. The carriage as claimed in claim 23,
said second pivotal joint being spaced between the first and third pivotal joints so that the intermediate frame section operates as a walking beam.

28. The carriage as claimed in claim 23,
said third pivotal joint permitting relative pivotal movement between the intermediate frame section and the second base frame about a second base pivot axis,
said base pivot axes being substantially parallel to the intermediate pivot axis.

29. The carriage as claimed in claim 23,
said first and third pivotal joints each permitting relative pivotal movement between the intermediate frame section and the respective base frame about at least two substantially orthogonal pivot axes.

30. The carriage as claimed in claim 29; and
a pair of pivot blocks each interconnecting a corresponding one of the base frames and the intermediate frame section,
each of said pair of pivot blocks being pivotally attached to the intermediate frame section about a first one of the pivot axes and pivotally attached to the respective base frame about a second one of the pivot axes.

31. The carriage as claimed in claim 23,
said base frames each including an opening that receives the intermediate frame section therein,
said base frames each being operable to contact the intermediate frame section along the respective opening in a selected orientation to limit relative pivotal movement therebetween.

32. The carriage as claimed in claim 23,
said third pivotal joint permitting relative pivotal movement between the intermediate frame section and the second base frame about a second base pivot axis,
said intermediate frame section being pivotal relative to one of the base frames in a first direction about the respective base pivot axis,
said intermediate frame section being configured to engage said one of the base frames when said intermediate frame section has pivoted into a base-engaging position, wherein further pivoting of the intermediate frame section relative to said one of the base frames in the first direction is prevented,
one of said caster wheels of one of the corresponding caster assemblies being spaced from the corresponding pivotal joint in the first direction, such that any pivoting of the intermediate frame section in the first direction beyond the base-engaging position occurs about said one of said caster wheels.

33. The carriage as claimed in claim 32,
said intermediate frame section contacting said one of the base frames at a contact location when said intermediate frame section is pivoted into the base-engaging position,
said one of said caster wheels being spaced further in the first direction from the corresponding pivotal joint than the contact location.
